(19) United States
(12) Patent Application Publication
(10) Pub. No.: US 2025/0234326 A1
(43) Pub. Date: Jul. 17, 2025

(54) SYSTEMS AND METHODS FOR POSITIONING ENHANCEMENT OF WIRELESS DEVICES

(71) Applicant: ZTE Corporation, Shenzhen (CN)

(72) Inventors: Mengzhen LI, Shenzhen (CN); Chuangxin JIANG, Shenzhen (CN); Yu PAN, Shenzhen (CN); Focai PENG, Shenzhen (CN); Cong WANG, Shenzhen (CN)

(73) Assignee: ZTE Corporation, Shenzhen (CN)

(21) Appl. No.: 18/890,968

(22) Filed: Sep. 20, 2024

Related U.S. Application Data
(63) Continuation of application No. PCT/CN2023/076892, filed on Feb. 17, 2023.

(51) Int. Cl. H04W 64/00; H04L 5/00

(52) U.S. Cl. CPC H04W 64/00; H04L 5/001; H04L 5/0051

(57) ABSTRACT

The present arrangement relates to systems, methods, and non-transitory computer-readable media for receiving a configuration for a downlink reference signal for bandwidth aggregation; receiving the downlink reference signal; and determining positioning measurement result for the downlink reference signal for the bandwidth aggregation.

### CROSS-REFERENCE TO RELATED APPLICATION

This application claims the benefit of priority under 35 U.S.C. § 120 as a continuation of International Patent Application No. PCT/CN2023/076892, filed on Feb. 17, 2023, the disclosure of which is incorporated herein by reference in its entirety.

### TECHNICAL FIELD

The disclosure relates generally to wireless communications and, more particularly, to carrier aggregation (CA) or bandwidth (BW) aggregation.

### BACKGROUND

In 5^{th} Generation Mobile Network System (5GC), CA is a key technology in new radio (NR) systems. CA features may include aggregation of two or more component carriers.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, configuration for a downlink reference signal for bandwidth aggregation and the downlink reference signal according to the configuration are received. A wireless communication device can determine positioning measurement result for the downlink reference signal for the bandwidth aggregation based on the downlink reference signal.

In some arrangements, configuration for a downlink reference signal for bandwidth aggregation and the downlink reference signal according to the configuration is sent. A network can receive, from a wireless communication device, positioning measurement result for the downlink reference signal for the bandwidth aggregation.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 is a diagram illustrating an example component carrier aggregation, according to various arrangements.

FIG. 4 is a diagram illustrating an example wireless communication, according to various arrangements.

FIG. 5 is a diagram illustrating an example resource mapping, according to various arrangements.

FIG. 6 is a diagram illustrating an example muting pattern, according to various arrangements.

FIG. 7 is a diagram illustrating an example resource configuration for positioning reference signals (PRS), according to various arrangements.

FIG. 8 is a diagram illustrating an example muting pattern, according to various arrangements.

FIG. 9 is a diagram illustrating an example bandwidth aggregation, according to various arrangements.

FIG. 10 is a diagram illustrating an example wireless communication, according to various arrangements.

FIG. 11 is a diagram illustrating an example wireless communication, according to some arrangements.

FIG. 12 is a diagram illustrating an example aggregation, according to various arrangements.

FIG. 13 is a diagram illustrating an example medium access control element (MAC-CE), according to various arrangements.

FIG. 14 is a diagram illustrating an example MAC-CE, according to various arrangements.

FIGS. 15A and 15B are diagrams illustrating example wireless communications, according to various arrangements.

FIG. 16 is a flowchart diagram illustrating an example method for positioning enhancement of wireless devices, according to various arrangements.

FIG. 17 is a flowchart diagram illustrating an example method for positioning enhancement of wireless devices, according to various arrangements.

FIG. 18 is a diagram illustrating an example mapping for positioning enhancement of wireless devices, according to various arrangements.

FIG. 19 is a diagram illustrating an example mapping for positioning enhancement of wireless devices, according to various arrangements.

FIG. 20 is a diagram illustrating an example mapping for positioning enhancement of wireless devices, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless device may communicate with a network. As part of the communication process, the wireless device may perform various positioning procedures (e.g., to determine a location of the wireless device, a position relative to the network, a location of the network, etc.). In some cases, the wireless device may perform a positioning procedure with the network via a UU interface by sending sounding reference signals (SRS) and/or receiving positioning reference signals (PRS). In some cases, using larger bandwidth (e.g., more bandwidth, more frequency resources) may result in higher accuracy positioning (e.g., the larger the bandwidth the higher the positioning accuracy), especially for timing-based positioning methods (e.g., time difference of arrival (TDOA), round trip time (RTT)). In carrier aggregation (CA), two or more component carriers (CCs) are aggregated. A wireless device may simultaneously receive or transmit on one or multiple CCs depending on the capabilities of the wireless device. The arrangement disclosed herein provides enhancements (e.g., additions, updates, changes) to reference signals bandwidth through carrier aggregation technology. To do so, wireless communications systems may use methods and procedures of signaling transfer to specify positioning in CA scenarios considering multiple states of the wireless device (e.g., RRC_INACTIVE state and RRC_CONNECTED state).

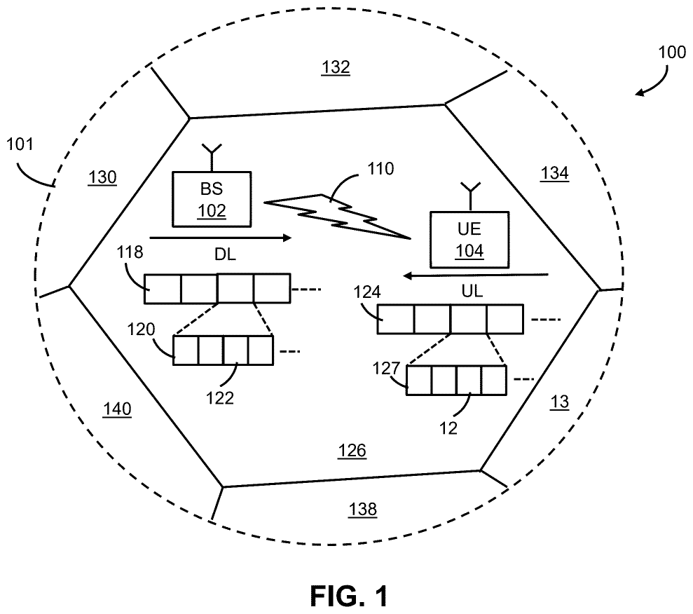

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support CA. For example, CA is a key technology to enlarge bandwidth in wireless communication. For high accuracy positioning, especially when timing-based positioning methods (e.g., TDOA, RTT) are used, the larger the bandwidth, the higher the positioning accuracy. The techniques described herein may provide enhancements to various aspects of reference signal positioning procedures. For example, a wireless communication device may receive, by the wireless communication device from a first node of a network, configuration for a downlink reference signal for bandwidth aggregation. The wireless communication device may receive, by the wireless communication device from a second node (e.g., a base station, a gNB, NG radio access network (NG-RAN)) of the network, the downlink reference signal according to the configuration. The wireless communication device may determine positioning measurement result for the downlink reference signal for the bandwidth aggregation. In some examples, the downlink reference signal may include a downlink PRS (DL-PRS). In some cases, the network may include a location management function (LMF) (e.g., the first node) and a base station (e.g., the second node).

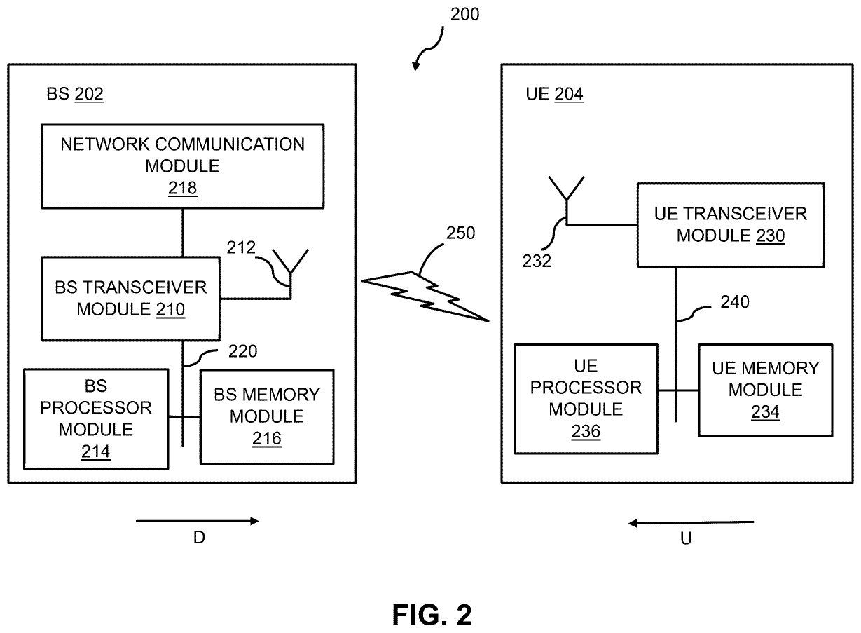

FIG. 2 illustrates a block diagram of an example wireless communication system 200 for transmitting and receiving wireless communication signals, e.g., orthogonal frequency division multiplexing (OFDM)/orthogonal frequency division multiple access (OFDMA) signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

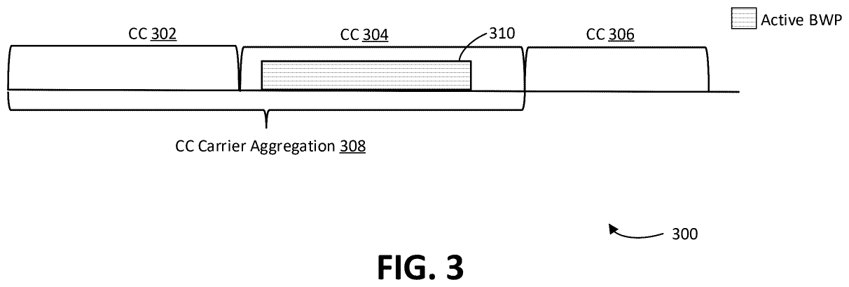

FIG. 3 is a diagram illustrating an example aggregation 300, according to various arrangements. The aggregation 300 may be an intra-band contiguous carrier aggregation. For example, component carrier (CC) 302 may be aggregated with CC 304 (e.g., CC carrier aggregation 308), where an aggregation of CC 302 and CC 306 may be an example of intra-band noncontiguous carrier aggregation. In some cases, the frequency resource 310 may be an active bandwidth part (BWP).

In some examples, from a downlink perspective, subject to user equipment (UE) capability, a UE in an RRC_INACTIVE state is expected to process downlink PRS outside or inside of the initial downlink BWP 310. In some examples, from an uplink perspective, subject to UE capability, the UE in RRC_INACTIVE state may be configured with an SRS resource for positioning associated with the initial uplink BWP 310, and the SRS resource is transmitted inside the initial uplink BWP with a same cyclic prefix (CP) and subcarrier spacing (SCS) as configured for the initial uplink BWP. Subject to UE capability, the UE may be configured with an SRS resource for positioning outside the initial BWP 310 including frequency location and bandwidth, subcarrier spacing, and CP length for transmission of the SRS in RRC_INACTIVE mode. The SRS resource for positioning outside of the initial BWP 310 in RRC_INACTIVE mode may be configured (e.g., pre-configured, configured via a configuration message sent by a network, etc.) in the same band and CC as the initial uplink BWP 310. In some wireless communications systems, the signaling and procedure of positioning in a single carrier (e.g., 100 MHz in frequency range (FR), 400 MHz in FR2) may be specified, however, bandwidth aggregation technology can further improve the positioning accuracy (e.g., meeting a demand for higher accuracy in wireless communication).

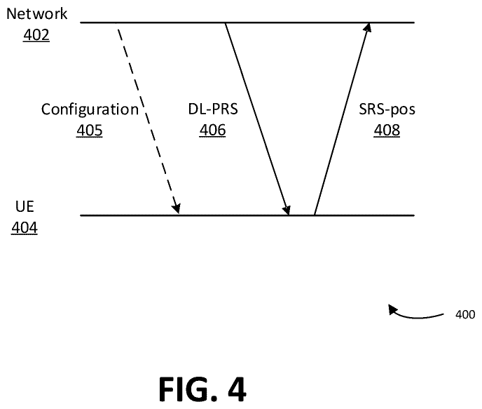

FIG. 4 is a diagram illustrating an example wireless communication 400, according to various arrangements. The wireless communication 400 may include a network 402 (e.g., a base station, a gNB, NG-RAN, access and mobility management function (AMF), LMF, etc.) and a UE 404. In some cases, the network 402 may include multiple network entities (e.g., nodes). For example, the wireless communication 400 may support LTE positioning protocol (LPP) signaling, NR positioning protocol A (NRPPa) signaling, or both. In some examples, the network 402 may include a first node (e.g., an LMF) of the network 402 and a second node (e.g., a base station, gNB, NG-RAN, etc.) of the network 402.

For example, the wireless communication 400 may include the network 402 transmitting a downlink PRS (DL-PRS) 406 to the UE 404 and the UE 404 transmitting an SRS positioning (SRS-pos) 408 to the network 402. For example, responsive to the UE 404 receiving the DL-PRS 406, the UE 404 may measure and process resources of the DL-PRS 406. The corresponding signaling may include PRS configuration for positioning in CA scenarios, a measurement report, a measurement period requirement, or any combination thereof. Subject to UE capability, the UE 404 may transmit the SRS 408 for positioning configuration and according to an SP SRS medium access control-control element (MAC-CE) design (e.g., for sidelink physical layer filtering).

In some examples, enlarging a positioning reference signal (e.g., PRS, SRS-pos) bandwidth through carrier aggregation technology may result in higher positioning accuracy. For positioning in RRC_INACTIVE state, the positioning assistance data or PRS configuration 405, as described herein, can be delivered to the UE 404 through various ways. In a first example, the way may include positioning system information (e.g., system information block for positioning (posSIB)). In a second example, the way may include pre-configure assistance data when UE 404 is in RRC_CONNECTED state. In a third example, the way may include the network 402 sending to the UE 404 in RRC_INACTIVE state during ongoing small data transmission (SDT) procedure. Additionally, or alternatively, SRS for positioning in RRC_INACTIVE state can be configured through either RRCRelease with SuspendConfig or SDT downlink (DL) radio resource control (RRC) message (e.g., Msg B/Msg 4 of random access (RA)-SDT). In some cases, a CC can also be a serving cell or positioning frequency layer (PFL) to be aggregated in a CA scenario.

PRS assistance data and/or configuration (e.g., higher layer link for PFL) may be described. For example, the UE 404 may be configured with one or more DL-PRS PFL configurations, as indicated by LMF (of the network 402) via DL-PRS assistance data. Alternatively, the UE 404 can receive the positioning system information (e.g., posSIB) containing positioning assistance data broadcast from the network 402 (e.g., gNB via RRC signaling). A DL PRS PFL may be defined by the LMF as a collection of DL PRS resource sets which share some common parameters (SCS, resource bandwidth, start physical resource block (startPRB), point A, comb size, and cyclic prefix). In order to achieve high-accuracy positioning (e.g., for TDOA and RTT methods) aggregation of PRS resources across PFLs for positioning measurements may be supported. Various method examples are provided for enabling the PRS bandwidth aggregation.

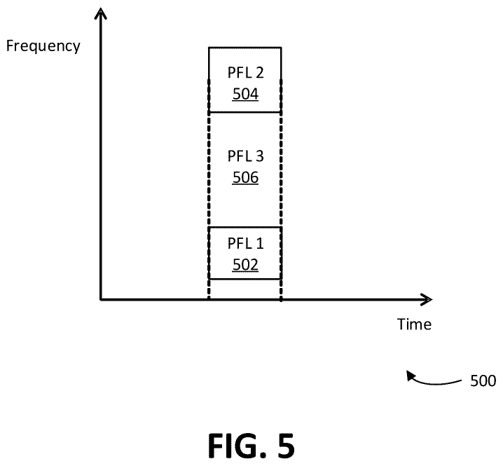

In a first example method, the UE 404 may receive a configuration from the network 402, where the configuration includes higher layer signaling and an indicator. The higher layer signaling may indicate that multiple PFLs are linked. The indicator may indicate whether each of the multiple PFLs for the downlink reference signal is used for bandwidth aggregation, where each of the multiple PFLs comprise a set of at least one resource for the downlink reference signal. For example, multiple PFLs used for bandwidth aggregation may be associated and/or linked via higher layer signaling (e.g., LPP signaling). The network 402 (e.g., LMF) may explicitly inform the UE 404 which two or three PFLs are linked for aggregation. An indicator (e.g., Bandwidth-aggregation-ind) can be introduced for each PFL, indicating whether a particular PFL is used for bandwidth aggregation or not (e.g., a Boolean value). For example, with reference to FIG. 5, the UE 404 may be configured with three DL-PRS PFLs 406 (e.g., PFL1 502, PFL2 504, PFL3 506). The network 402 (e.g., LMF) may indicate that PFL1 502 and PFL3 506 are associated and used for bandwidth aggregation and PFL 2 504 is not used for bandwidth aggregation via LPP signaling. FIG. 5 is a diagram illustrating an example resource mapping 500, according to various arrangements. The mapping 500 may outline a PFL resource mapping order in time and frequency (e.g., DL-PRS resources in multiple PFLs transmitting at the same time).

In a second example method, the configuration includes higher layer signaling and an indicator. The higher layer signaling may indicate that multiple PFLs used for bandwidth aggregation are linked. The indicator may indicate a reference PFL for each of the multiple PFLs for the downlink reference signal, each of the multiple PFLs including a set of at least one resource for the downlink reference signal. For example, multiple PFLs used for bandwidth aggregation are associated and/or linked via higher layer signaling (e.g., LPP signaling). An indicator (e.g., Reference-PFL-ID) can be introduced for PFL indicating a reference PFL for a PFL. In some cases, if one PFL is not configured with a reference PFL ID, the PFL is not used for bandwidth aggregation. If one PFL is configured with a reference PFL ID, the PFL is configured for bandwidth aggregation and the DL-PRS configured within the PFL is associated with or refers to the DL-PRS configured within the reference PFL. In some examples, a reference PFL may be the PFL itself.

For example, the UE 404 may be configured with four DL-PRS PFLs (PFL0, PFL1, PFL2, PFL3), LMF may indicate a reference PFL associated with PFL0 is PFL1 502 and a reference PFL associated with PFL3 is PFL2 504. In such case, a first PFL group (e.g., group 1) may include “PFL0+PFL1” and a third group (e.g., group 3) may include “PFL2+PFL3”. For each PFL group, two PFLs may be used for bandwidth aggregation. Additionally, DL-PRS resources to be aggregated from two or more PFLs are transmitted simultaneously to be equivalent to larger bandwidth DL-PRS resources (e.g., PFL2 504, PFL3 506, and PFL1 502 are transmitted at a same time).

In some cases, the reference PFL is selected from multiple PFLs based on one or more rules. The rules may include: the reference PFL has a largest bandwidth among the multiple PFLs; the reference PFL corresponds to a first resource having a largest reception power among resources corresponding to the plurality of PFLs; or the reference PFL corresponds to a second resource having a largest transmission power among the resources corresponding to the plurality of PFLs. For example, from a network configuration perspective, some common parameters may apply (e.g., for DL-PRS configurations for multiple PFLs or multiple DL-PRS resource sets to be aggregated). The common parameters can refer to the reference PFL, reference DL-PRS resource set, or be configured via higher layer signaling. The network 402 can decide which PFL/DL-PRS resource set is the reference PFL/DL-PRS resource set based on one or more rules (e.g., the PFL which have the largest bandwidth can be the reference PFL or the PFL whose DL-PRS resource have the maximum reference signal receive power (RSRP) or transmission power can be selected as the reference PFL).

In some examples, the common parameters (e.g., configuration parameters) may include at least one of the following: SCS, Transmission-Reception Point (TRP) identification (ID), antenna reference point (ARP), DL-PRS periodicity, the number of DL-PRS resource set, the number of PRS resources in the linked PRS resource sets, DL-PRS resource set slot offset, DL-PRS resource repetition factor, time gap, muting pattern, DL-PRS symbol number, DL-PRS resource slot offset, DL-PRS resource symbol offset, DL-PRS comb size and RE offset, DL-PRS sequence ID, Priority of the DL-PRS, DL-PRS QCL info, Power for DL-PRS transmission, DL-PRS expected reference signal timing difference (RSTD) and expected RSTD uncertainty.

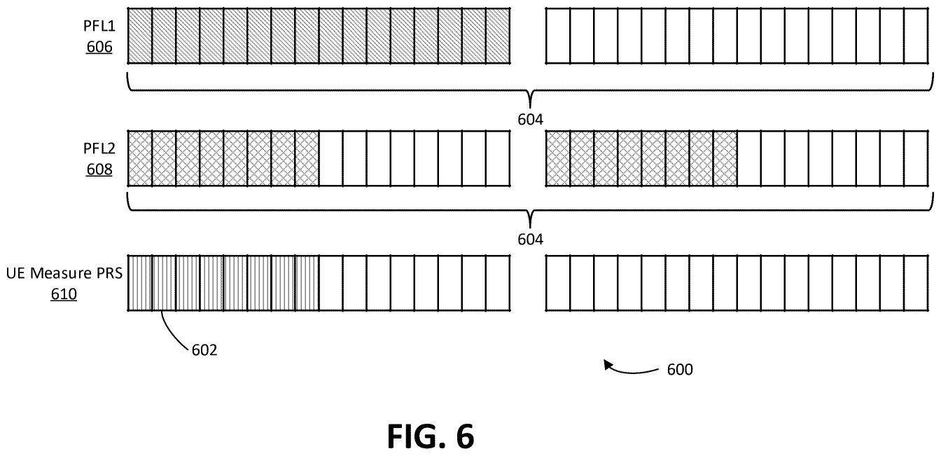

FIG. 6 is a diagram illustrating an example muting pattern 600, according to various arrangements. The muting pattern 600 may include two associated PFLs (PFL1 606 and PFL2 608) with different muting patterns 604 (including resources 602).

With reference to the first and second examples described with reference to FIGS. 4 and 5, if two or more PFLs are associated and/or linked, the DL-PRS configuration under each PFL is independent, regardless of which example is applied. Therefore, some restrictions may be introduced for multiple associated PFLs (e.g., PFL1 606 and PFL2 608). For example, if multiple PFLs are linked, the configuration (e.g., DL-PRS configuration) may include an indicator indicating whether a configuration parameter of the downlink reference signal is enabled. The indicator may be an enable/disable indicator (e.g., introduced via the network 402) to specify whether one or some of the DL-PRS configuration parameters are enabled or disabled.

In some cases, a wireless device (e.g., UE 404) may receive the downlink reference signal according to a transmission time indicated in downlink reference signal assistance data. For example, if the DL-PRS configuration under each PFL is independent but no enable/disable indicator is introduced, then the UE 404 may receive the DL-PRS based on the common transmission time according to DL-PRS assistance data. The network 402 may choose the common transmission time instance to transmit DL-PRS. For example, if the muting pattern for two associated PFLs 606 and 608 is different, the empty instance may indicate that DL-PRS in that instance is muted. The UE 404 may determine muting time instances associated with the two PFLs 606 and 608 and measure and process DL-PRS which are transmitted simultaneously in the two PFLs 606 and 608 (e.g., measured PRS 610).

In some cases, other assistance data for UE-based positioning may be included in the configuration. For example, LMF can provide the position calculation assistance data and a UE (e.g., UE 404) may request the position calculation assistance data from LMF. One or more parameters may be part of the position calculation assistance data, which may be updated based on the CA configuration. The configuration may include one or more parameters, such as: first beam information for a first resource of a first resource set of the downlink reference signal for a first PFL; second beam information for a second resource of a second resource set of the downlink reference signal for a second PFL; the first beam information is same as the second beam information; and the first PFL and the second PFL are associated with a same TRP and are in a same PFL group. Additionally, or alternatively, the configuration may include a timing error margin for all TRP transmission timing error groups (TEGs) for multiple linked PFLs. For example, a first parameter may be NR-DL-PRS-BeamInfo (e.g., used by the location server to provide spatial direction information of the DL-PRS resources). In some cases, DL-PRS beam information for DL-PRS Resource i of the DL-PRS Resource Set j in PFL 1 is the same as the DL-PRS beam information for DL-PRS Resource i of the DL-PRS Resource Set j in PFL 2, wherein PFL1 and PFL2 are associated with the same TRP and the same PFL group or associated with the reference PFL or the PFL within initial DL BWP.

A second parameter may be NR-DL-PRS-TRP-TEG-Info (e.g., used by the location server to provide the association information of DL-PRS Resources with TRP Tx timing error group (TEGs)). In some cases, for DL-PRS resources associated with one PFL group, a new IE may be introduced to represent the timing error margin for all the TRP Tx TEGs contained within one NR-DL-PRS-TRP-TEG-InfoPerFreqLayerGroup (e.g., TRP Tx TEG ID associated with the transmissions of each DL-PRS Resource of the PFL group) or associated with the reference PFL or the PFL within initial DL BWP. In some cases, DL-PRS TRP Tx TEG ID in PFL 1 is the same as the DL-PRS TRP Tx TEG ID in PFL 2, wherein PFL1 and PFL2 are associated with the same TRP and the same PFL group or associated with the reference PFL or the PFL within initial DL BWP.

A third parameter may be NR-RTD-Info (e.g., used by the location server to provide time synchronization information between a reference TRP and a list of neighbor TRPs). In some cases, RTD-InfoListPerFreqLayer may be associated with RTD-InfoListPerFreqLayerGroup or associated with the reference PFL or the PFL within initial DL BWP. In some cases, DL-PRS TRP RTD info in PFL 1 is the same as the DL-PRS TRP RTD info in PFL 2, wherein PFL1 and PFL2 are associated with the same TRP and the same PFL group or associated with the reference PFL or the PFL within initial DL BWP.

A fourth parameter may be NR-TRP-LocationInfo (e.g., used by the location server to provide the coordinates of the antenna reference points for a set of TRPs. For each TRP, the ARP location can be provided for each associated PRS Resource ID per PRS Resource Set). In some cases, NR-TRP-LocationInfoPerFreqLayer may be associated with NR-TRP-LocationInfoPerFreqLayerGroup or associated with the reference PFL or the PFL within initial DL BWP. In some cases, DL-PRS TRP and ARP location information in PFL 1 is the same as the DL-PRS TRP and ARP location information in PFL 2, wherein PFL1 and PFL2 are associated with the same TRP and the same PFL group or associated with the reference PFL or the PFL within initial DL BWP.

A fifth parameter may be NR-TRP-BeamAntennaInfo (e.g., used by the location server to provide beam antenna information of the TRP). In some cases, NR-TRP-BeamAntennaInfoPerFreqLayer may be associated with NR-TRP-BeamAntennaInfoPerFreqLayerGroup or associated with the reference PFL or the PFL within initial DL BWP. In some cases, DL-PRS beam antenna information in PFL 1 is the same as the DL-PRS beam antenna information in PFL 2, wherein PFL1 and PFL2 are associated with the same TRP and the same PFL group or associated with the reference PFL or the PFL within initial DL BWP. In some cases, to maximize the performance gain of bandwidth aggregation, DL-PRS resources of multiple aggregated PFLs are expected to be transmitted by the same TRP via the same antenna panel, aiming at the same spatial direction (e.g., to ensure performance and positioning accuracy).

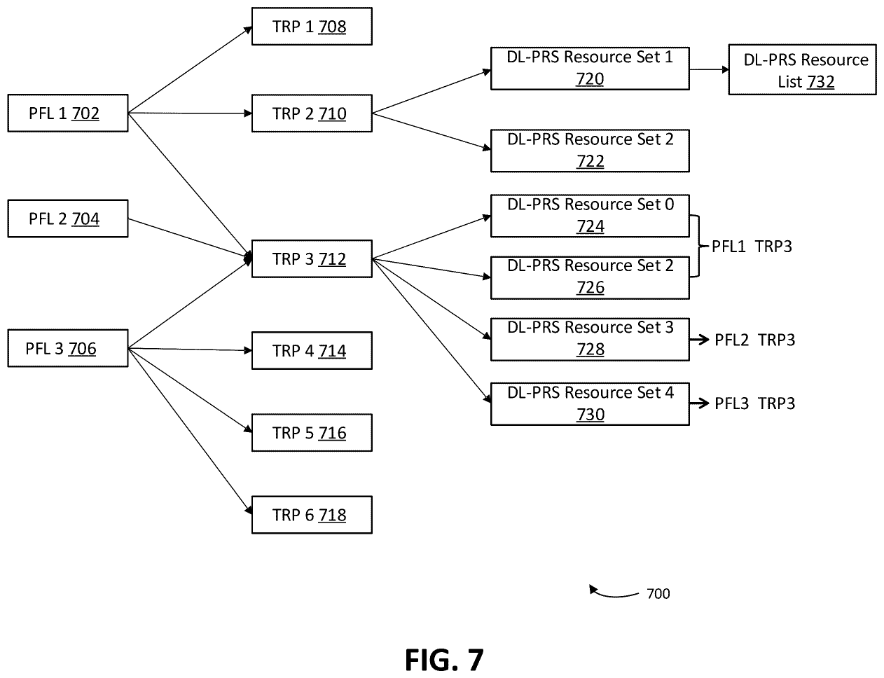

FIG. 7 is a diagram illustrating an example resource configuration 700, according to various arrangements. The resource configuration 700 may be an example DL-PRS resource configuration structure. In some cases, the resource configuration 700 may support PRS assistance data and/or configuration (e.g., higher layer link for PRS resource set per TRP).

In some cases, resources for the downlink reference signal aggregated from multiple PFLs are transmitted by a same TRP, where two or more resource sets for the downlink reference signal are associated with the TRP. For example, the DL-PRS Resource Set ID may be used to identify the DL-PRS Resource Set of a TRP across all frequency layers. In some cases, if DL-PRS resources that are to be aggregated from different PFLs are transmitted by the same TRP, then the DL-PRS resource set IDs of the TRP for multiple PFLs may not be the same. Per PFL per TRP, a UE may be configured with at most two DL-PRS resource sets. By restricting the DL-PRS resources to be aggregated from multiple PFLs to be transmitted by the same TRP and configuring one TRP to be associated with more than two DL-PRS resource sets, DL-PRS resources associated with at least two PFLs are aggregated.

For example, assistance data for TRP1 708, TRP2 710, and TRP3 712 may be configured within PFL1 702, assistance data for TRP3 712 may be configured within PFL2 704, and assistance data for TRP3 712, TRP4 714, TRP5 716, and TRP6 718 are configured within PFL3 706. In such case, TRP3 712 is associated with three PFLs (PFL1 702, PFL2 704, and PFL3 706). The DL-PRS resource set IDs per PFL1 702 per TRP3 712 (resource set 724 and resource set 726) are different from that per PFL2 704 per TRP3 712 (resource set 728) or per PFL3 706 per TRP3 712 (resource set 730).

In some cases, an indicator specifying whether the DL-PRS resources or DL-PRS resource sets within one TRP are intended for bandwidth aggregation can also be designed within the assistance data per TRP or within the PRS configuration per TRP. In a first example, the configuration may include an indicator indicating whether at least one resource or resource set for a TRP for the downlink reference signal is used for bandwidth aggregation, where the indicator is an assistance data specific to the TRP. For instance, assistance data for a TRP (e.g., NR-DL-PRS-AssistanceDataPerTRP in LPP) may include an indicator (e.g., Bandwidth-aggregation-ind) specifying whether the DL-PRS resources configured in the TRP, used for bandwidth aggregation, can be introduced in the assistance data per TRP.

In a second example, the configuration may include at least one of: a list of resource sets for the downlink reference signal for a TRP, the list of resource sets are used for bandwidth aggregation; or a list of resources for a resource set for the downlink reference signaling used for the bandwidth aggregation. For instance, the assistance data per TRP may include PRS configuration (e.g., NR-DL-PRS-Info) that includes the DL-PRS resource set and DL-PRS resource configuration. The assistance data may include a parameter (e.g., nr-DL-PRS-ResourceSetList-CA in NR-DL-PRS-Info, the maximum number of resource sets for bandwidth aggregation can be set as 6) specifying a list 732 of DL-PRS resource sets for one TRP used for bandwidth aggregation. In some cases, the list of DL-PRS resource sets used for bandwidth aggregation may be linked (e.g., associated with each other). Additionally, or alternatively, the assistance data may include a parameter specifying a list of DL-PRS resource (e.g., dl-PRS-ResourceList-CA in NR-DL-PRS-ResourceSet) for one resource set used for bandwidth aggregation.

In a third example, the configuration may include either a first indicator indicating whether a resource set for the downlink reference signal is used for bandwidth aggregation, the first indicator in assistance data for a TRP or a second indicator indicating whether a resource for the downlink reference signal is used for the bandwidth aggregation, the second indicator in the assistance data for the TRP. For instance, each DL-PRS resource set (720, 722, 724, 726, 728, and 730) may be configured with an indicator specifying whether the DL-PRS resource set is used for bandwidth aggregation. Additionally, or alternatively, each DL-PRS resource may be configured with an indicator specifying whether the DL-PRS resource is used for bandwidth aggregation.

In a fourth example, the configuration may include an indicator indicating a reference resource set of a resource set for the downlink reference signal, the indicator in assistance data for a TRP. For instance, the assistance data per TRP may include an indicator (e.g., Reference-DL-PRS-ResourceSetID) for DL-PRS resource set indicating a reference DL-PRS resource set for the DL-PRS resource set. For example, if the DL-PRS resource set 722 is not configured with a reference DL-PRS resource set ID, then the DL-PRS resource set 722 is not used for bandwidth aggregation. If the DL-PRS resource set 724 is configured with a reference DL-PRS resource set ID, then the DL-PRS resource set 724 is configured for bandwidth aggregation and the DL-PRS resource configured within the DL-PRS resource set 724 is associated with the DL-PRS resource configured within the DL-PRS resource set 724. In some cases, the reference DL-PRS resource set for the DL-PRS resource set 724 may be the DL-PRS resource set 724.

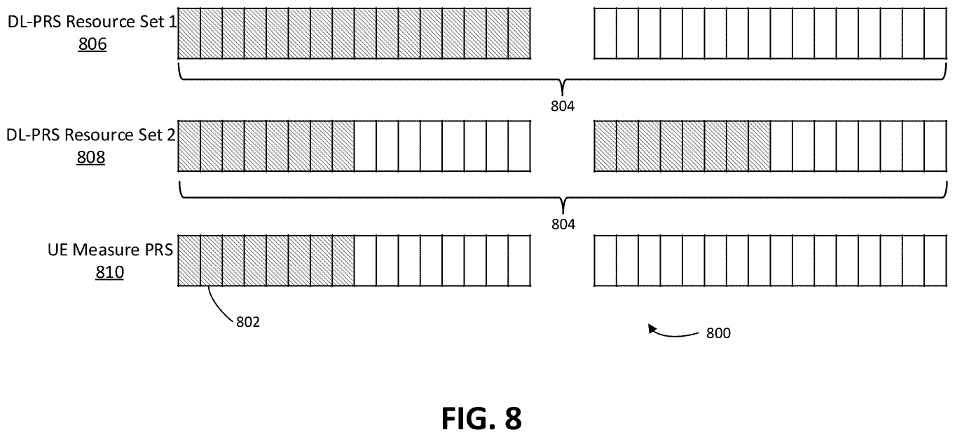

FIG. 8 is a diagram illustrating an example muting pattern 800, according to various arrangements. The muting pattern 800 may include a first resource set 806 and a second resource set 808 associated with the first resource set 806 with different patterns 804. A UE may measure PRS 810 associated with the two resource sets 806 and 808 based on the muting patterns 804. For example, when two or more DL-PRS resource sets (e.g., resource sets 806 and 808) or DL-PRS resources are associated/linked, the DL-PRS configuration under each DL-PRS resource set 806 and 808 is independent, regardless of which example (e.g., examples one through four described herein with reference to FIG. 7) is applied.

In some cases, a network (e.g., LMF, gNB) can introduce an enable/disable indicator to specify whether one or some of the DL-PRS configuration parameters (e.g., SCS, TRP ID, ARP, DL-PRS periodicity, DL-PRS symbol number, DL-PRS resource slot offset, DL-PRS resource symbol offset, DL-PRS comb size and RE offset, DL-PRS sequence ID, Priority of the DL-PRS, DL-PRS quasi co-location (QCL) info, Power for DL-PRS transmission, DL-PRS expected RSTD and expected RSTD uncertainty) are enabled or disabled. If the DL-PRS configurations under each DL-PRS resource set are independent but no enable/disable indicator is introduced, then a UE may receive the DL-PRS based on the common transmission time according to DL-PRS assistance data. In some cases, the network may select the common transmission time instance to transmit DL-PRS. For example, if the muting pattern 804 for two associated DL-PRS resource sets 806 and 808 are different, then the empty instance may indicate DL-PRS in that instance is muted. The UE may measure and process DL-PRS 810 during which DL-PRS are transmitted simultaneously in the two DL-PRS resource sets 806 and 808 (e.g., using two muting time instances).

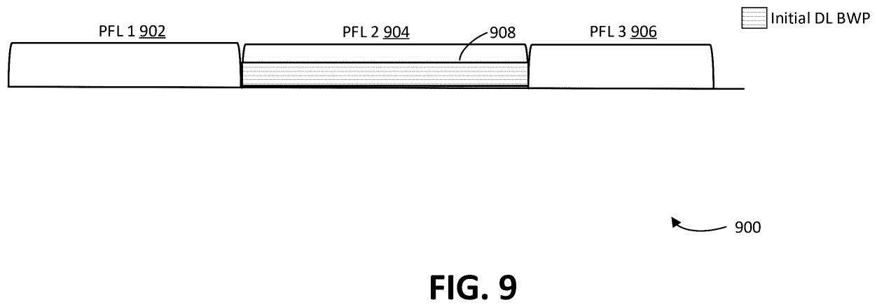

FIG. 9 is a diagram illustrating an example aggregation 900, according to various arrangements. The aggregation 900 may be an example of PRS PFL aggregation for a UE in RRC_INACTIVE state or for a UE in RRC_CONNECTED state. The aggregation 900 may include PFL1 902, PFL2 904, and PFL3 906, where PFL2 904 may include an initial downlink BWP 908. In some examples, the aggregation 900 may support PRS assistance data/configurations for downlink bandwidth aggregation (e.g., information element (IE) for CA).

In some cases, to support downlink bandwidth aggregation, a new field or new IE may be introduced. The new field (e.g., NR-DL-PRS-PositioningFrequencyLayer-CA) may be for a list of frequency layers for CA. Multiple PFLs within the field/IE may share at least one of various parameters. For example, the configuration for a downlink reference signal may include a list of PFLs for bandwidth aggregation, where the PFLs share at least one of SCS, comb size, CP, or assistance data per TRP. In some cases, each PFL (e.g., NR-DL-PRS-PositioningFrequencyLayer-CC) may have a respective resource bandwidth, start PRB, and point A. The assistance data per TRP can include at least one or more of the following: TRP ID (e.g., dl-PRS-ID), physical cell identity, NR cell global identifier (NCGI) (e.g., globally unique identity of a cell in NR), absolute radio frequency channel number (ARFCN) associated with a cell defining synchronization signal block (CD-SSB) of a TRP, SFN0 offset, ARP, DL-PRS periodicity, DL-PRS resource set slot offset, DL-PRS resource repetition factor, time gap, muting pattern, DL-PRS symbol number, DL-PRS resource slot offset, DL-PRS resource symbol offset, DL-PRS comb size and resource element (RE) offset, DL-PRS sequence ID, Priority of the DL-PRS, DL-PRS QCL info, power for DL-PRS transmission, DL-PRS expected RSTD and expected RSTD uncertainty.

In some examples, to support positioning bandwidth aggregation for a UE in RRC_INACTIVE state, multiple embodiments to configure DL-PRS bandwidth aggregation may be possible. In a first embodiment, the configuration for a downlink reference signal may include either a first bandwidth aggregation configuration for bandwidth aggregation of the downlink reference signal and a second bandwidth aggregation configuration for bandwidth aggregation of the downlink reference signal, the first bandwidth aggregation configuration is used for an RRC-connected state of a wireless communication device, and the second bandwidth aggregation configuration is used for an RRC-inactive state of the wireless communication device; or a bandwidth aggregation configuration for bandwidth aggregation of the downlink reference signal for both the RRC-connected state of the wireless communication device and the RRC-inactive state of the wireless communication device. For example, respective configurations may include NR-DL-PRS-PositioningFrequencyLayer-CA and NR-DL-PRS-PositioningFrequencyLayer-CA-inactive and a single configuration may include NR-DL-PRS-PositioningFrequencyLayer-CC.

In a second embodiment, the configuration for the downlink reference signal may include a bandwidth aggregation configuration for bandwidth aggregation of the downlink reference signal for an RRC-inactive state of a wireless communication device and multiple associated PFLs associated with the downlink reference signal within an initial downlink BWP for the RRC-inactive state of the wireless communication device. For example, when one DL-PRS bandwidth aggregation configuration dedicated to a UE in RRC_INACTIVE state is introduced, the configuration of multiple associated PRS PFLs (e.g., PFL1 902, PFL2 904, and PFL3 906) are associated with the PRS inside the initial downlink BWP 908 for the UE in RRC_INACTIVE state. In some cases, only the PFLs with an SCS and CP for PRS resources that are the same as those of the initial downlink BWP 908 can be used for bandwidth aggregation. For instance, PFL1 902, PFL2 904, and PFL3 906 are associated and used for bandwidth aggregation and only the PRS resources in PFL2 904 are located within the initial downlink BWP 908. PFL1 902 and PFL3 906 share the DL-PRS resource configuration of PFL2 904 including the SCS and CP.

In a third embodiment, the configuration for the downlink reference signal may include multiple PFLs associated with a reference PFL for the downlink reference signal for an RRC-inactive state of a wireless communication device. In some cases, a first SCS of the multiple associated PFLs, a second SCS of an initial downlink BWP, a first CP of the multiple associated PFLs, and a CP SCS of the initial downlink BWP are same or different. In some cases, the reference PFL may be within the initial downlink BWP, and at least one resource configured in the reference PFL is within the initial downlink BWP; or the reference PFL is outside of the downlink BWP, and the at least one resource configured in the reference PFL is outside of the initial downlink BWP. For example, if the configuration of multiple associated PRS PFLs are associated with a reference PRS PFL for a UE in RRC_INACTIVE state, then the reference PFL may either be inside the initial downlink BWP 908 (e.g., the DL-PRS resources configured in the reference PFL is inside the initial downlink BWP 908) or outside the initial downlink BWP. In such a case, the SCS and CP of multiple associated PFLs can either be the same as or different from those of the initial downlink BWP 908. In some cases, two or more of the various embodiments may be combined.

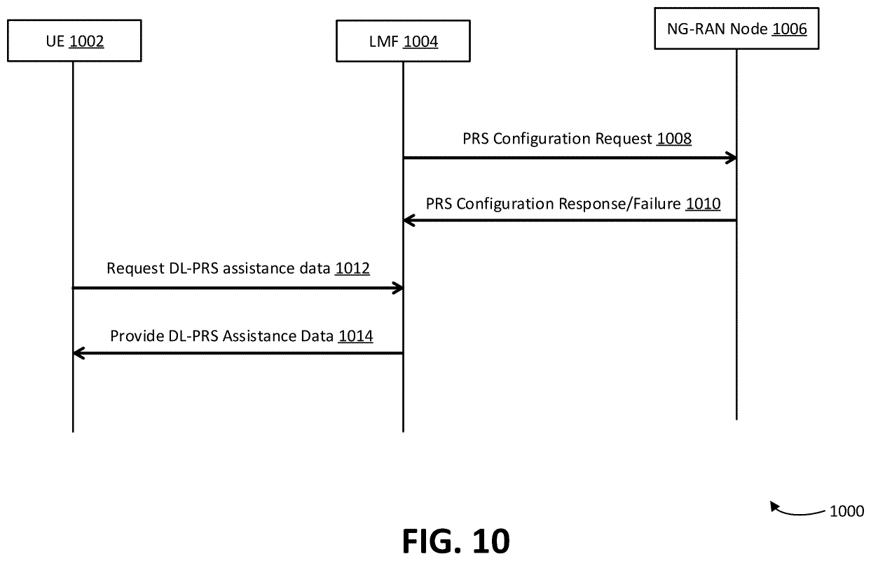

FIG. 10 is a diagram illustrating an example wireless communication 1000, according to various arrangements. The wireless communication 1000 may include a UE 1002, an LMF 1004, and an NG-RAN node 1006. In some cases, the LMF 1004 may be a first node of a network (e.g., a network node) and the node 1006 may be a second node of a network (e.g., a network node). The wireless communication 1000 may support signaling procedures for PRS assistance data. In some examples, the signaling presented in wireless communication 1000 may represent signaling between LMF 1004 and NG-RAN node 1006 and the request signaling sent from UE 1002 to LMF 1004.

In some cases, the LMF 1004 and the node 1006 may perform a PRS configuration exchange procedure. The LMF 1004 may send a request for a configuration for a downlink reference signal for bandwidth aggregation, the request including a bandwidth aggregation indicator. The indicator may include either a bit indicating whether bandwidth aggregation for the downlink reference signal is needed, or multiple bits indicating whether the bandwidth aggregation for the downlink reference signal is needed and a number of PFLs used for the bandwidth aggregation. For instance, the LMF 1004 may send a PRS configuration request 1008 to the node 1006. The request 1008 may include information listed in the IE containing the request PRS configuration for transmission by the LMF 1004. The information may include a PRS bandwidth such that the LMF 1004 may request large bandwidth for DL-PRS resource set (e.g., if the requested bandwidth is larger than 272 PRBs then bandwidth aggregation related configuration is enabled); a bandwidth aggregation indicator that may include either one bit (e.g., 0 representing no bandwidth aggregation configuration for PRS is needed, 1 representing the opposite) or multiple bits (e.g., 0 or 00 representing no bandwidth aggregation configuration for PRS is needed, where the larger the number the higher the number of frequency layers are used for bandwidth aggregation); and/or a number of frequency layers for bandwidth aggregation.

The node 1006 may send a response to the LMF 1004 with PRS configuration. For example, the response may be a PRS configuration response/failure 1010. The response 1010 may include information listed in the IE containing the PRS configuration for the TRP. The information may include an indicator specifying whether the DL-PRS resources/resource sets configured in the TRP is used for bandwidth aggregation; a parameter specifying a list of DL-PRS resource sets for the TRP used for bandwidth aggregation; a parameter specifying a list of DL-PRS resource for one resource set used for bandwidth aggregation; an indicator for each DL-PRS resource set specifying whether the respective DL-PRS resource set is used for bandwidth aggregation; an indicator for each DL-PRS resource specifying whether the respective DL-PRS resource is used for bandwidth aggregation; an indicator for DL-PRS resource set indicating a reference DL-PRS resource set for the DL-PRS resource set; and/or a reference DL-PRS resource set ID and configurations associated with the reference DL-PRS resource set.

The UE 1002 may transmit a request 1012 for DL-PRS assistance data to the LMF 1004. The request 1012 may include information listed in the IE including the requested PRS configuration for transmission by the UE 1002. The information may include an indicator specifying whether PRS bandwidth aggregation is requested; an indicator for each requested PFL indicating whether the PFL is used for bandwidth aggregation; an indicator for PRS bandwidth (e.g., the UE 1002 may request large bandwidth for DL-PRS resource set); an indicator requesting reference PFL ID; and/or an indicator requesting a PFL group. In response to receiving the request 1012, the LMF 1004 may send the DL-PRS assistance data to the UE 1002 via signaling 1014.

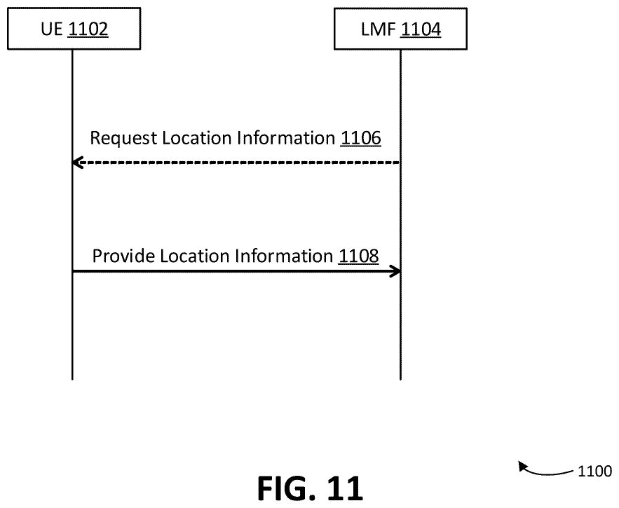

FIG. 11 is a diagram illustrating an example wireless communication 1100, according to some arrangements. The wireless communication 1100 may include a UE 1102 and an LMF 1104. In some cases, the wireless communication 1100 may be a location information transfer procedure.

In some cases, the UE 1102 may report a PRS measurement. For example, the UE 1102 may receive, from the LMF 1104 (e.g., a network), a measurement request (e.g., a request for location information 1106) indicating that the wireless communication device is requested to report a positioning measurement result for bandwidth aggregation (e.g., based on a downlink reference signal). The UE 1102 may report, to the LMF 1104, the positioning measurement result, where the result includes at least one of a measurement indicator, a first identifier of a first resource or a first resource set, a second identifier of a second resource or a second resource set, and/or a list of resource set identifiers or resource identifiers. The measurement indicator may indicate that the positioning measurement result is determined by aggregating resources of a same TRP for the downlink reference signal. The first identifier for measuring the downlink reference signal and the second identifier for measuring the downlink reference signal for a measurement element. The list for measuring the downlink reference signal for each TRP for a measurement element.

In some cases, for an LMF-initiated location information transfer procedure, the LMF 1104 may first send a request location information message 1106 to the UE 1102 and the UE 1102 may respond to the LMF 1106 with location information 1108. In some cases, for UE-initiated location information transfer procedure, the UE 1102 may send the location information message 1108 to the LMF 1104 via LPP signaling (e.g., without receiving the request 1106).

In some examples, the request 1106 may include information listed in the IE that includes the requested measurement for transmission by the LMF 1104. The information may include a DL-PRS CA measurement request that indicates whether the target device is requested to report DL-PRS bandwidth aggregation measurements; measurement request for a certain PFL group; a number of aggregated DL-PRS resource sets that indicate the number of aggregated DL-PRS resource sets that the UE 1102 (e.g., the target device) is requested to measure and report for one TRP or per pair of TRPs; and/or a maximum number of aggregated DL-PRS resource sets per TRP or per pair of TRPs that indicate the maximum number of aggregated DL-PRS resource sets that the target device is requested to measure and report for one TRP or per pair of TRPs. The maximum number may be defined across all positioning frequency layers.

In some examples, the location information 1108 may include information listed in the IE that includes the positioning measurement for transmission by the UE 1102. The information may include a DL-PRS CA measurement indicator (e.g. nr-DL-PRS-CA-ind) that indicates whether the measurement element provided by the UE 1102 is derived by aggregated DL-PRS resources from a TRP (e.g., dl-PRS-ID); one or more additional DL-PRS resource set IDs for each positioning measurement provided by the UE 1102 per TRP, where for one measurement (e.g. RSTD, Rx-Tx time difference) one DL-PRS resource ID and DL-PRS resource set ID may be provided; and/or a list of DL-PRS resource set ID and DL-PRS resource ID for each positioning measurement provided by the UE 1102 per TRP, where for one measurement element (e.g. RSTD, Rx-Tx time difference) the UE 1102 may provide a list of DL-PRS resource set IDs (e.g., nr-DL-PRS-ResourceSetID-list) and DL-PRS resource IDs (e.g., nr-DL-PRS-ResourceID-list); whether/which one or two or three PFLs are used for measurement and report. In some cases, for the additional DL-PRS resource set ID, for a CA case, the UE 1102 may need to additionally provide more DL-PRS resource set and DL-PRS resource ID information for one measurement. For example, for each DL-TDOA measurement reporting element (e.g., NR-DL-TDOA-MeasElement), the UE 1102 may provide a DL-PRS resource set ID attached with additional DL-PRS resource set IDs (e.g., nr-DL-PRS-additional-ResourceSetID or nr-DL-PRS-additional-ResourceSetID-list) and DL-PRS resource ID attached with additional DL-PRS resource IDs (e.g., nr-DL-PRS-additional-ResourceID or nr-DL-PRS-additional-ResourceID-list).

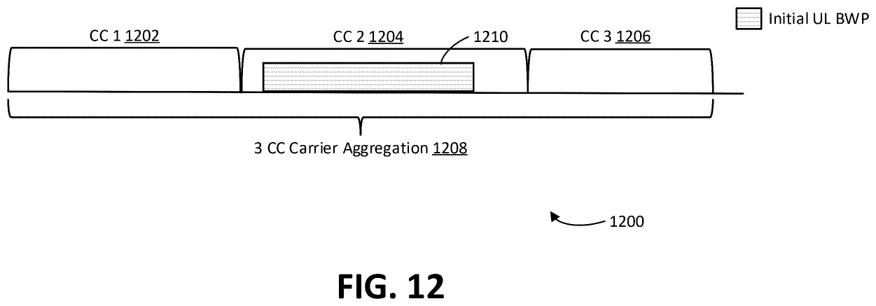

FIG. 12 is a diagram illustrating an example aggregation 1200, according to various arrangements. The aggregation 1200 may include a first CC 1202, a second CC 1204, and a third CC 1206. The aggregation 1200 may be an example of three CC carrier aggregation, where the CC 1202, the CC 1204, and the CC 1206 are aggregated together as CC CA 1208. In some cases, the CC 1204 may include an initial uplink BWP 1210.

From the uplink perspective, a UE in RRC_INACTIVE mode may be configured with an SRS resource for positioning inside or outside the initial BWP 1210. The SRS resource for positioning outside the initial BWP 1210 in RRC_INACTIVE mode is configured in the same band and CC as the initial uplink BWP 1210 (e.g., CC 1204). However, the available bandwidth is quite limited for UE transmitting SRS in RRC_INACTIVE state. At least one of the following SRS types (periodic, semi-persistent, aperiodic) may be supported for bandwidth aggregation positioning for UE in RRC_CONNECTED mode or in RRC_INACTIVE mode.

An SRS for positioning purposes that is transmitted among multiple CCs simultaneously may significantly enlarge the bandwidth of SRS resource, which may result in increased positioning accuracy. For a UE in an RRC_INACTIVE state, the initial uplink BWP is configured in CC 1204. Based on UE capability, the UE may be configured to transmit SRS in CC 1202, CC 1204, and/or CC 1206. In some cases, the CC aggregation 1208 may be multiple associated SRS.

In some cases, an SRS signaling procedure may be described. For example, a UE may receive from a base station (e.g., a second node of a network) an SRS configuration for bandwidth aggregation. The UE may send to the base station an SRS according to the SRS configuration. In a first example, the SRS configuration for multiple CCs may be associated with an SRS configuration within an initial uplink BWP (e.g., BWP 1210) or with a CC including the initial BWP (e.g., CC 1204). In a second example, a priority of sending the SRS on an initial CC of the multiple CCs is higher than sending the SRS on another CC of the plurality of CCs. In a third example, the SRS configuration for the plurality of CCs is associated with a reference CC. In some implementations, the UE may receive multiple first cells via RRC signaling and multiple second cells via RRC signaling used in the bandwidth aggregation for the SRS, where the multiple second cells are selected based on the multiple first cells. In some cases, one or all of the examples may be used by a wireless communications system.

In a first example, for one CC group, the configuration of SRS in multiple CCs is associated with SRS configuration inside the initial uplink BWP 1210 or the CC 1204 that includes the initial uplink BWP 1210. In some cases, based on UE capability, SRS resources can be configured both within the initial uplink BWP 1210 and outside the initial uplink BWP 1210. In some examples, if the UE supports uplink positioning bandwidth aggregation, the priority of sending SRS on the initial CC is higher than on other CCs. For example, if the UE sends SRS on only one CC, the default configuration is transmitting SRS on CC 1204. If sending SRS on two CCs, the default configuration is transmitting SRS on either CC 1204 and CC 1202 or CC 1204 and CC 1206. If sending SRS on three CCs, the default configuration is transmitting SRS on CC 1204 and CC 1202 and CC 1206. In a second example, the configuration of SRS in multiple CCs is associated with a reference CC. In a third example, the reference CC may be inside or outside the initial uplink BWP 1210. In a fourth example, the SCS and the CP of the SRS resource may be the same or different from the SCS and CP of the initial uplink BWP 1210. In a fifth example, based on UE capability, SRS resources may be configured for the UE outside of the initial uplink BWP 1210 with the configuration including frequency domain location and bandwidth, SCS, and CP. In some cases, two or more of the examples may be combined.

In some examples, the SRS configuration for the bandwidth aggregation may be for an RRC-inactive state in an RRC release message. In some cases, one of an IE may contain the SRS configuration without changing an RRC-inactive configuration and a suspend configuration, or the SRS configuration for the bandwidth aggregation are added to the RRC-inactive configuration and the suspend configuration. In some cases, to support SRS carrier aggregation, an additional SRS configuration in a serving cell other than the one of initial BWP should be introduced and informed by RRC release signaling. For example, the configuration may be configured in an RRC release according to either a first method including adding a new IE (e.g., SRS-PosRRC-InactiveCAConfig) including SRS CA related configuration for UE in RRC_INACTIVE state without changing SRS-PosRRC-InactiveConfig in SuspendConfig, or a second method including updating the SRS-PosRRC-InactiveConfig in SuspendConfig by adding SRS CA related configuration for UE in RRC_INACTIVE state (e.g., additional-ServingCell-list, additional-ServingCell, each additional-ServingCell include at least one of the following: serving cell ID, srs-PosConfigNUL, bwp-NUL-r17, inactivePosSRS-TimeAlignmentTimer, inactivePosSRS-RSRP-ChangeThreshold, absoluteFrequencyPointA, p-Max, frequencyShift7p5khz).

In some examples, the SRS CA related configuration may include one of the following. The SRS configuration may include a list of additional serving cells other than an initial CC for the bandwidth aggregation, each of the additional serving cell is associated with or includes one or a list of BWP configuration and positioning SRS configuration. Multiple serving cells involved in bandwidth aggregation share a same time alignment timer and received power (e.g., RSRP) change threshold. The SRS configuration includes the SRS position configuration of multiple associated BWPs that share a common SRS configuration received from the network or corresponding to a reference SRS position configuration. The common SRS configuration may include one or more of SRS resource set ID, SRS resource set ID list, SRS resource ID, SRS resource ID list, resource type (aperiodic, semi-persistent, periodic), alpha value for SRS power control, p0 value for SRS power control, pathloss reference RS (SSB, DL-PRS), number of SRS port, transmission comb size, comb offset, cyclic shift, resource mapping (start position, number of symbols), frequency domain shift, frequency hopping, group or sequence hopping, sequence ID, and/or spatial relation information (serving cell RS, SSB, DL-PRS). To maximize the performance gain, SRS resources on multiple aggregated CCs may be transmitted based on the same spatial relation, a number of SRS resource sets (e.g., the SRS resource sets in the linked carriers can be one-to-one linked by default, where the SRS resource set m in carrier i is linked with SRS resource set m in carrier i+1), and/or a number of SRS resources for positioning (e.g., the SRS resources in the linked SRS resource sets in the linked carriers can be one-to-one linked by default, where the nth SRS resource in SRS resource set m in carrier i is linked with the nth SRS resource in the SRS resource set m in carrier i+1). The SRS configuration includes different spatial relation configurations for different CCs (e.g., SSB in CC 1202 and DL-PRS in CC 1204), where the network enables a first spatial relation of the different spatial relation configurations and disables a second spatial relation of the different spatial relation configurations.

The SRS CA related configuration may also include one of the following. The SRS configuration may include a list of serving cells and the SRS resources configured within the list of serving cells are associated and participate in carrier aggregation, each serving cell is associated with or includes one of a list of BWP configuration or SRS-pos configuration. The SRS configuration may include a list of BWPs which participate in carrier aggregation, where each BWP configuration is associated with a list of SRS-pos configuration. For the list of BWPs to be aggregated (e.g., the BWP may be configured for each serving cell), a location and bandwidth of the BWPs are different but have the same SCS and CP config. A reference serving cell and/or a reference BWP can be indicated to the UE, in such case, the SRS-pos configuration of other serving cells/BWPs can be associated with the SRS-pos configuration of the reference cell/BWP (e.g., reference SRS-pos configuration). Each serving cell involving bandwidth aggregation may be independently configured with a time alignment timer and RSRP change threshold.

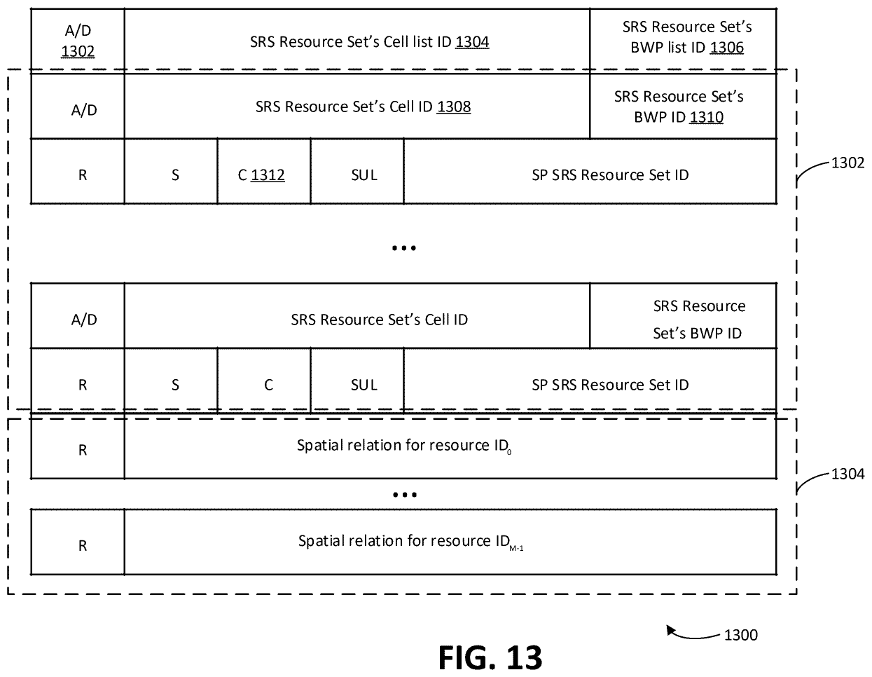

FIG. 13 is a diagram illustrating an example MAC-CE 1300, according to various arrangements. The MAC-CE 1300 may include fields 1302 for multiple activated cells selected from a cell list and fields 1304 for spatial relation information which correspond to resource ID i in one serving cell and resource ID i in another serving cell. The MAC-CE 1300 may be an SP positioning SRS activation/deactivation MAC-CE.

For periodic SRS for positioning, the linkage between carriers configured by RRC may be sufficient. After RRC configuration, SRS in different linked carriers are transmitted periodically in the same symbols. Then, TRPs can do SRS measurement and report based on the aggregated SRS transmission. In some cases, for semi-persistent SRS, a wireless communication device may receive, from a network, an SRS activation/deactivation MAC-CE for bandwidth aggregation. The MAC-CE 1300 may include at least one of a list of activated serving cell identifiers, the list of activated serving cell identifiers being a subset of a list of RRC-configured serving cell identifiers; or a list of activated BWP identifiers, the list of activated BWP identifiers being a subset of a list of RRC-configured BWP identifiers. In some cases, this may provide a flexibility to choose some or all of the serving cells/BWPs to activate or deactivate. In some examples, for semi-persistent positioning SRS (SP SRS), the network may provide multiple SRS resources and/or resource sets configurations to a UE via RRC. The network may use a MAC-CE to activate/deactivate one or more SRS resources and/or resource sets of a BWP and a serving cell. For semi-persistent SRS activation/deactivation, one or more of the following options may apply. A first option may include, when a carrier i is linked with a carrier j by RRC signaling for positioning SRS BW aggregation, a MAC CE activating/deactivating a SRS resource set with ID m in carrier i may activate/deactivate the SRS resource set with ID m in the carrier j. A second option may include, when a carrier i is linked with a carrier j by RRC signaling for positioning SRS BW aggregation, a MAC CE activating/deactivating a SRS resource set with ID m in carrier i can either activate/deactivate the SRS resource set with ID m in carrier i or activate/deactivate the SRS resource sets with ID m in both carrier i and carrier j.

In some cases, a MAC-CE can schedule SRS resources or SRS resource sets from multiple CCs, where the SRS resources are transmitted simultaneously in multiple CCs. The MAC-CE 1300 may activate SRS resources or SRS resource sets of the reference CC or the CC which includes an initial uplink BWP, the association between reference CC and other corresponding CCs may be configured by higher layer signaling, indicating that once the reference CC is activated/deactivated, the corresponding CCs are simultaneously activated/deactivated. The MAC-CE 1300 may be a new MAC-CE or a modification of a previous MAC-CE. In some cases, the modified MAC-CE may include either an indicator to indicate whether the MAC-CE 1300 is used for CA use cases or an indicator to indicate whether the activated SRS resource set is from the reference serving cell and/or BWP.

In some examples, RRC may provide one or multiple serving cell lists and/or BWP lists each configured with an ID. The MAC-CE 1300 may also include a cell list ID 1304 and BWP list ID 1306 for the SRS resource set, and choose one or more SRS resource set cell/BWP to activate and one or more SRS resource set cell/BWP to deactivate.

In some examples, spatial relation information corresponding to resource ID i in one serving cell and resource ID j in another serving cell may be the same, where those two SRS resources are associated and expected to be transmitted simultaneously. For example, MAC-CE 1300 may indicate to activate SRS resource set 1 and SRS resource set 2. Each resource set includes three SRS resources (SRS resource 1, 2, and 3), the spatial relation information of SRS resource 1 in SRS resource set 1 and that of SRS resource 1 in SRS resource set 2 are the same and transmitted simultaneously.

In some cases, the MAC-CE 1300 may include a first field 1302, a second field 1304, a third field 1306, a fourth field 1308, a fifth field 1310, and a sixth field 1312. The field 1302 may indicate whether to activate or deactivate indicated SP positioning SRS resource set. The field is set to one to indicate activation and otherwise indicate deactivation. The field 1304 may be a cell list ID configured in higher layers. The field 1306 may be a BWP list ID configured in higher layers. The field 1308 may be a cell ID indicating that identity of the serving cell. The serving cell may include activated/deactivated SP positioning SRS resource sets. If the field 1312 (e.g., the C field) is set to zero, then the field 1308 may also indicate the identity of the serving cell that includes all resources indicated by the spatial relation for resource ID i fields, if present. The length of the field 1308 may be five bits. The field 1310 may be a BWP ID that indicates an uplink BWP as the codepoint of the downlink control information (DCI) bandwidth part indicator field, which includes activated/deactivated SP positioning SRS resource sets. If the field 1312 is set to zero, the field 1310 may also indicate the identity of the BWP which includes all resources indicated by the spatial relation for resource ID i fields, if present. The length of the field 1310 may be two bits.

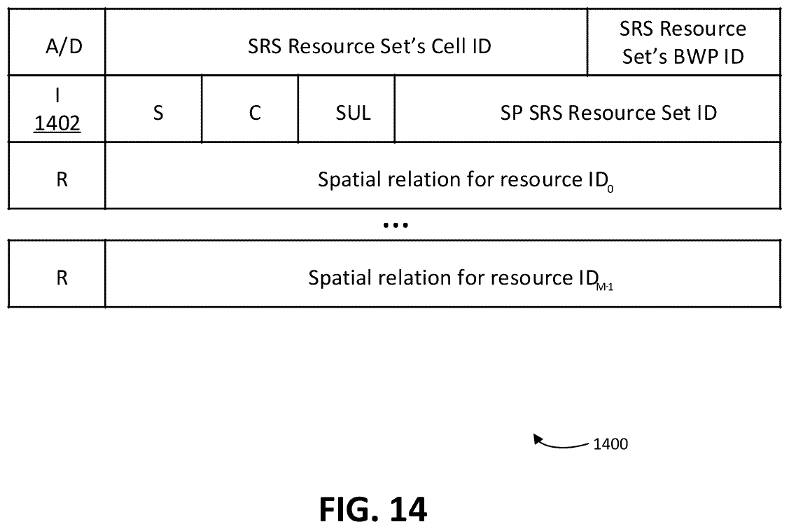

FIG. 14 is a diagram illustrating an example MAC-CE 1400, according to various arrangements. The MAC-CE 1400 may include one or more fields associated with the MAC-CE 1300. The MAC-CE 1400 may also include the field 1402 (e.g., an I field). In some cases, the MAC-CE 1400 may be an example of modifying a MAC-CE to be a MAC-CE for SP positioning SRS activation/deactivation for CA case.

In some cases, the field 1402 may indicate whether the MAC-CE 1400 is used for CA cases and/or indicates whether the activated SRS resource set is from the reference serving cell/BWP. For example, if field 1402 is equal to one, the MAC-CE 1400 may be used for CA, otherwise, the MAC-CE 1400 may be a MAC-CE used to activate/deactivate SRS resources in one serving cell and one BWP.

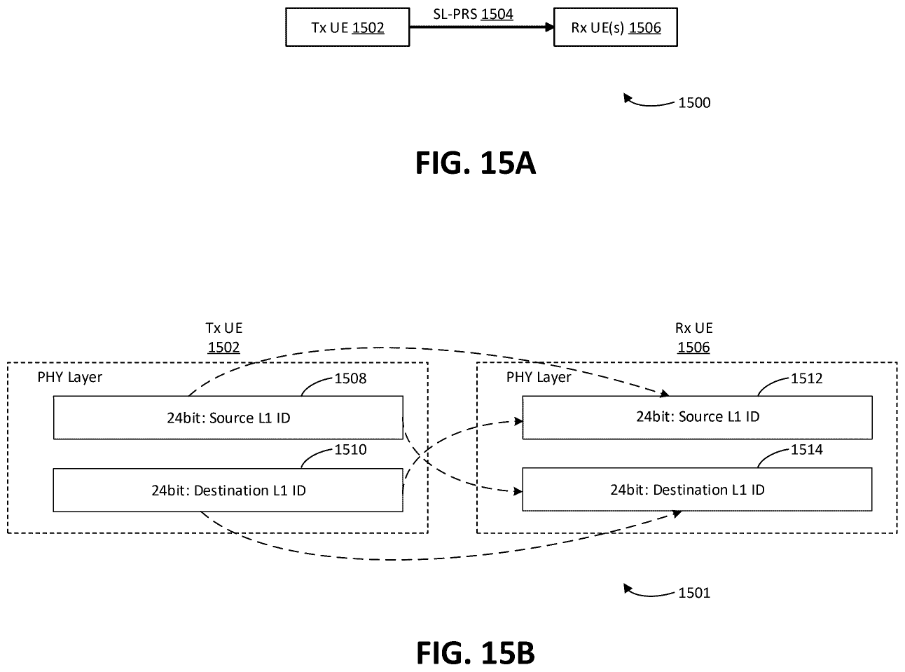

FIGS. 15A and 15B are diagrams illustrating example wireless communications 1500 and 1501, according to various arrangements. The wireless communications 1500 and 1501 may include a first UE 1502 and a second UE 1506 in sidelink wireless communication. For example, the UE 1502 may transmit a reference signal 1504 (e.g., SL-PRS) to the UE 1506. In some cases, the UE 1502 may be a transmitting UE and the UE 1506 may be a receiving UE.

In some cases, a UE may be out of the coverage of a network, the UE may be in coverage of the network but has a poor channel quality, and/or, the UE may determine to calculate a highly accurate location for the UE. For all of these use cases, sidelink technology can be applied (e.g., vehicle to everything (V2X) UEs to perform positioning). The embodiments described herein may provide for a physical layer filtering mechanism that enable a UE to verify a SL-PRS to be measured.

For NR sidelink positioning, to obtain location information of a target UE, positioning methods may use reference signals (e.g., SL-PRS 1504) transmitted between UEs. The resulting measurements can be used to locate the target UE. For example, a UE can be configured by higher layers with one or more sidelink resource pools (e.g., a resource pool which can be used for transmission/reception of SL-PRS or for positioning purposes may be a SL-PRS resource pool) for positioning purpose. The resource pools may be either a shared resource pool for sidelink communication or a dedicated resource pool for SL-PRS. An SL-PRS resource pool may be associated with either sidelink resource allocation scheme 1 (e.g., network-centric SL-PRS resource allocation) or sidelink resource allocation scheme 2 (e.g., UE autonomous SL-PRS resource allocation).

Some example filtering mechanisms may involve both Layer-1 (L1) filtering (physical layer filtering) and Layer-2 filtering (MAC layer filtering), where the filtering may be the mechanism to ensure that an SL-PRS from a “Tx UE-Rx UE” link is measured (e.g., rather than from a different link). The “Tx UE-Rx UE” link may be unicast, groupcast, or broadcast. For sidelink positioning, unlike sidelink data (carried in physical sidelink shared channel (PSSCH)), which signaling flow involves physical (PHY) layer, MAC layer, RLC layer, PDCP layer, NAS layer, SL-PRS may be generated, transmitted, received, and measured or processed in the PHY layer.

For an SL-PRS resource pool, sidelink control information (SCI), which includes cast type and source/destination UE information, is used to trigger and/or reserve SL-PRS resources. For example, if the cast type indicated in an SCI of a transmitter UE (e.g., UE 1502) is unicast, then the SL-PRS 1504 reserved by the SCI may be decoded by a particular receiver UE (e.g., UE 1506). The cast type can also be indicated as groupcast or broadcast, in which case, one source UE 1502 is associated with multiple destination UEs 1506. The multiple destination UEs 1506 may decode and measure the SL-PRS 1504 transmitted from the source UE 1502. The SCI may be a 1st stage SCI, a 2nd stage SCI, or an SCI designed for sidelink (SL) positioning.

In some cases, the UE 1502 may receive the SCI in a physical layer. The SCI may include a source identifier and a destination identifier. In some cases, the source identifier and the destination identifier may each be 24 bits long. In some cases, the UE 1502 may perform pure physical layer filtering using the source identifier and the destination identifier. The UE 1502 may receive a sidelink reference signal from the UE 1506 based on the SCI. For example, the UE 1502 may set the bit of source ID (containing source UE information) and the destination ID (containing destination UE information) in physical layer as 24 bits for pure physical layer filtering. If the SCI includes the source ID and destination ID, the source ID is enlarged from 8 bits to 24 bits and the destination ID is enlarged from 16 bits to 24 bits. If the SL-PRS sequence ID is associated with information associated with the UE 1502 and/or information associated with the UE 1506, the bits of each UE ID information is 24 bits.

In the example of FIG. 15B, the PHY layer of both UEs is represented. For example, the PHY layer of the UE 1502 may include a source ID 1508 and a destination ID 1510 and the PHY layer of the UE 1506 may include a source ID 1512 and a destination ID 1514. In a first example, if SL-PRS is configured in a dedicated SL-PRS resource pool and the case type indicated in the SCI of the UE 1502 is unicast, then the UE 1506 may determine if the 24 bits of the destination ID 1514 are equal to the 24 bits of the source ID 1508 and/or determine if the 24 bits of the source ID 1512 are equal to the 24 bits of the destination ID 1510. If the condition is met (e.g., they are equal), the UE 1506 may process the SL-PRS resources associated with the SCI of the UE 1502. In a second example, if SL-PRS is configured in a dedicated SL-PRS resource pool and if the cast type indicated in the SCI of the UE 1502 is groupcast and/or broadcast, then the UE 1506 may determine if the 24 bits of with the destination ID 1514 is equal to the 24 bits of the destination ID 1510 and/or determine if the 24 bits of the source ID 1512 is equal to the 24 bits of the source ID 1508. If the condition is met (e.g., they are equal), the UE 1506 may process the SL-PRS resources associated with the SCI of the UE 1502.

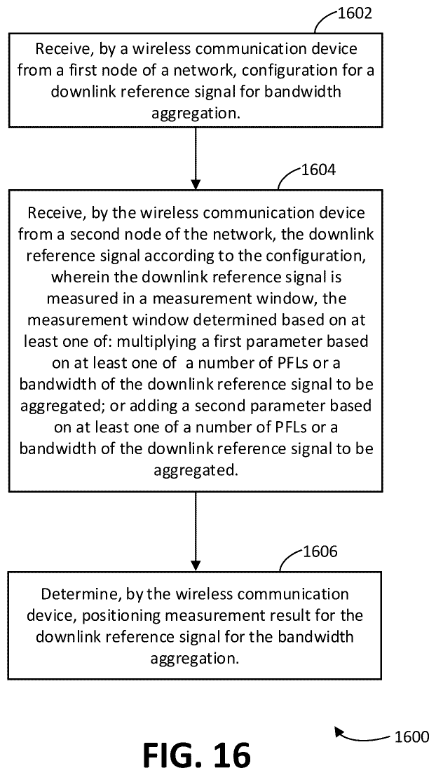

FIG. 16 is a flowchart diagram illustrating an example method 1600 for positioning enhancement of wireless devices, according to various arrangements. In some cases, the method 1600 may include PRS measurement windows (e.g., periods).

In some cases, for N2 or T2 cases, the equation of PRS processing window (PPW) measurement period in a CA scenario may be calculated according to the following equation:

$${T}_{RSTD , Total} = max ( {T}_{RSTD \_ wo \_ gap , i} + {T}_{uncertainty , i} ) , \qquad Equation 1$$

if all the positioning frequency layers are in case 2.

In a first example, if L₁ PFLs to be aggregated are case 2, then Tₜₒₜₐₗ may be calculated according to one or more of the following equations:

$${T}_{RSTD , Total} = {S}_{{L}_{1}} * max ( {T}_{RSTD \_ wo \_ gap , i} + {T}_{uncertainty , i} ) , \qquad Equation 2$$

where S_{L}_{₁}, is associated with the number of PFLs or the PRS bandwidth to be aggregated, L₁ is the number of positioning frequency layers which used for bandwidth/carrier aggregation, and i is the index of positioning frequency layer.

$${T}_{RSTD , Total} = max ( {T}_{RSTD \_ wo \_ gap , i} + {T}_{uncertainty , i} ) + {Δ}_{{L}_{1}} , \qquad Equation 3$$

where Δ_{L}_{₁} is associated with the number of PFLs or the PRS bandwidth to be aggregated.

In a second example, because the PRS is sent simultaneously on multiple PFLs in the carrier aggregation case, the PPW positions are the same on multiple carriers, and Tₜₒₜₐₗ may be derived from the calculation of the reference PFL. Due to complexity of processing multiple PFLs at the same time, the equation for calculating the reference PFL (e.g., r) may be updated to the following equation:

$${T}_{RSTD , Total} = ( {T}_{RSTD \_ wo \_ gap , r} + {T}_{uncertainty , r} ) , \qquad Equation 4$$

where T_{RSTD_wo_gap,i} may be calculated by one of the following equations:

$${T}_{RSTD \_ wo \_ gap , i} = ( {k}_{multiTEG , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} + {Δ}_{{L}_{1}} , or \qquad Equation 5$$

$${T}_{RSTD \_ wo \_ gap , i} = ( {S}_{{L}_{1}} * {k}_{multiTEG , i} * {N}_{RxBeam , i} * ⌈ \frac{{n}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} , \qquad Equation 6$$

where the scaling factor S_{L}_{₁} or the offset Δ_{L}_{₁} is associated with the number of PFLs or the PRS bandwidth to be aggregated.

For example, at 1602, a wireless communication device may receive, from a first node of a network, configuration for a downlink reference signal for bandwidth aggregation. At 1604, the wireless communication device may receive, from a second node of the network, the downlink reference signal according to the configuration. In some cases, the downlink reference signal for bandwidth aggregation is measured in a measurement window. The measurement window may be determined based on at least one of multiplying a first parameter based on at least one of a number of PFLs or a bandwidth of the downlink reference signal to be aggregated; or adding a second parameter based on at least one of a number of PFLs or a bandwidth of the downlink reference signal to be aggregated. At 1606, the wireless communication device may determine positioning measurement results for the downlink reference signal for the bandwidth aggregation.

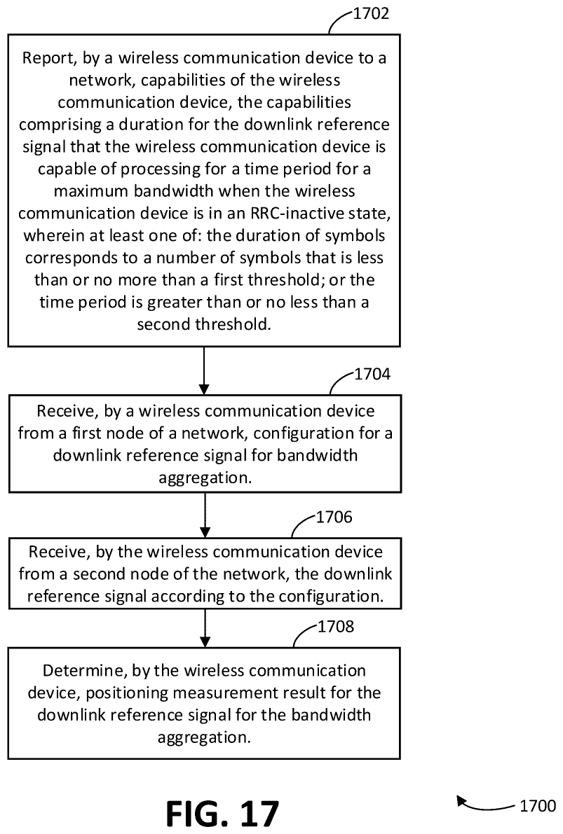

FIG. 17 is a flowchart diagram illustrating an example method 1700 for positioning enhancement of wireless devices, according to various arrangements. In some cases, the method 1700 may include reporting UE capability.

For example, a UE may report capabilities of the UE to a network to support positioning measurement in a frequency layer in a band. In some cases, the network may include LMF, gNB, or both. For the case of DL-PRS bandwidth aggregation where the UE may process DL-PRS from multiple aggregated PFLs, at least one of the following UE capabilities may be indicated. A capability may include support for PRS aggregation processing in RRC_INACTIVE state. A capability for RRC_INACTIVE may include support for a max number of aggregated PFL, where a UE in RRC_INACTIVE state can support aggregated measurement for maximum F frequency layers. A capability for RRC_INACTIVE may include support for a max number of aggregated DL-PRS resources per TRP, where a UE in RRC_INACTIVE state can support aggregated measurement for maximum S DL-PRS resource sets from one TRP. A capability may include support for maximum bandwidth considering bandwidth aggregation for UE in the RRC_INACTIVE state. A capability may include support for DL-PRS processing inside and outside initial downlink BWP, which may indicate that the UE has the capability to process DL-PRS in both inside and outside downlink BWP (e.g., for multiple PFL aggregation, if one PFL is inside the initial downlink BWP and the other PFLs are outside the initial downlink BWP). A capability may include support for a duration of DL-PRS symbols N_{f} in units of ms a UE can process every T_{f} ms for a given maximum bandwidth for a UE in RRC_INACTIVE state (e.g., assuming duration of DL-PRS symbols N in units of ms a UE can process every T ms for a given maximum bandwidth in non-CA scenarios). In some cases, one of the thresholds: the N_{f} is smaller than or no more than N: N=N-delta; or T_{f} is larger than or no less than T: T_{f}=T+delta may be met for the capability to support the duration. A capability may include support for the number of PRSs that can be processed per slot for the UE in RRC_INACTIVE state, where the number is reduced compared to non-CA scenarios. A capability may include support for DL-PRS processing samples in RRC_INACTIVE state for bandwidth aggregation cases. A capability may include support for aggregated PRS measurement in RRC_INACTIVE state for DL-TDOA. A capability may include support for aggregated PRS measurement in RRC_INACTIVE state for multi-RTT.

In some cases, for SRS bandwidth aggregation cases where the UE may transmit SRS for positioning purpose from multiple aggregated carriers, at least one of the following UE capabilities may be indicated. A capability may include support for positioning SRS transmission in RRC_INACTIVE state for initial uplink BWP (e.g., periodic). For example, max numbers of: SRS resource set, persistent/semi-persistent (P/SP) SRS resources, P/SP resources per slot, periodic SRS resources, and/or periodic SRS resources per slot, in CA scenarios may be supported. A capability may include support for positioning SRS transmission in RRC_INACTIVE state configured outside initial uplink BWP (e.g., periodic) For example, a bandwidth per SCS within one CC, a bandwidth per SCS within multiple aggregated CCs, different numerology and/or center frequency, support of SRS operation without the restriction on the CC, switching time between SRS CA transmission and other transmission in initial uplink BWP or receiving in initial downlink BWP, max numbers of: SRS resource set, P/SP SRS resources, P/SP resources per slot, periodic SRS resources, and/or periodic SRS resources per slot, in CA scenarios may be supported. A capability may include support for positioning SRS transmission in RRC_INACTIVE state configured both inside and outside initial uplink BWP (e.g., periodic). A capability may include support for positioning SRS transmission in RRC_INACTIVE state for initial BWP (e.g., semi-persistent). A capability may include support for positioning SRS transmission in RRC_INACTIVE state configured for outside initial uplink BWP (e.g., semi-persistent). A capability may include support for positioning SRS transmission in RRC_INACTIVE state configured both inside and outside initial uplink BWP (e.g., semi-persistent).

For example, at 1702, a wireless communication device may report, to a network, capabilities of the wireless communication device. The capabilities may include a duration for the downlink reference signal that the wireless communication device is capable of processing for a time period for a maximum bandwidth when the wireless communication device is in an RRC-inactive state. In some cases, the duration of symbols may correspond to a number of symbols that is less than or no more than a first threshold, or the time period may be greater than or no less than a second threshold. At 1704, the wireless communication device may receive, from a first node of a network, configuration for a downlink reference signal for bandwidth aggregation. At 1706, the wireless communication device may receive, from a second node of the network, the downlink reference signal according to the configuration. At 1708, the wireless communication device may determine positioning measurement results for the downlink reference signal for the bandwidth aggregation.

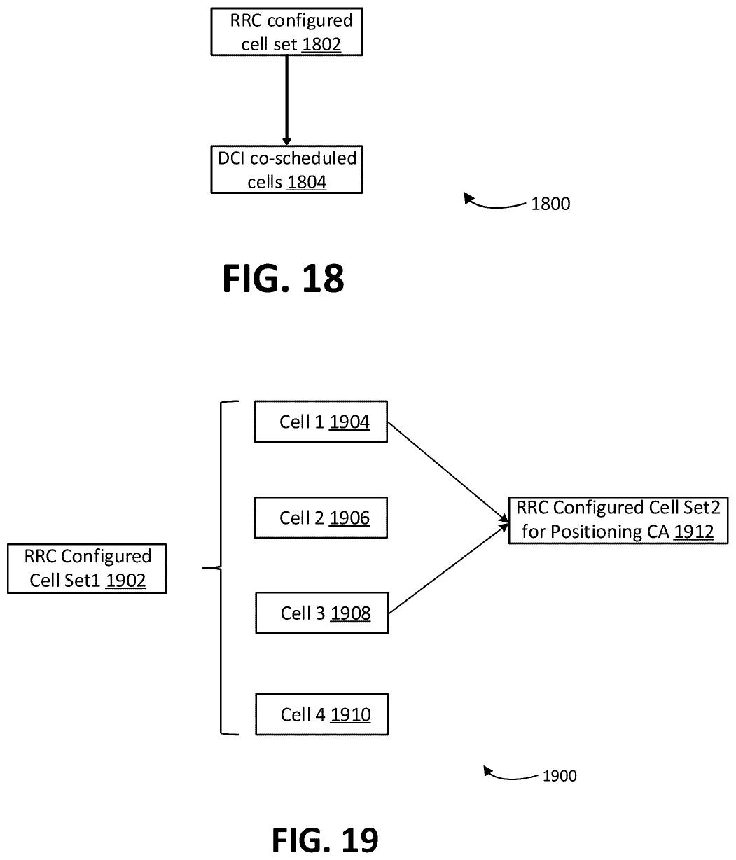

FIG. 18 is a diagram illustrating an example mapping 1800, according to various arrangements. The mapping 1800 may outline a mapping in one example embodiment for SRS DCI indication related to bandwidth aggregation. In some cases, the mapping 1800 may relate to multi-cell enhancements.

For aperiodic SRS, similarly as semi-persistent SRS, support for single DCI triggering SRS resource sets in the linked carriers together may reduce DCI overhead. In some cases, multiple physical downlink shared channel (PDSCH)/physical uplink shared channel (PUSCH) scheduled by a single DCI may reduce DCI control overhead and increase spectral efficiency in CA operation. For example, the maximum number of co-scheduled cells by a DCI format 1_X/0_X is four, such that a network may configure at most four cells for the DCI format 1_X/0_X. These four cells may make a set of cells that are configured via RRC signaling (e.g., RRC configured cell set1 1802). The DCI may also include an indicator of multiple co-scheduled cells (e.g., DCI co-scheduled cells 1804). In some cases, the DCI may include the indicator of the cells 1804 based on RRC configuration or a subset of RRC configured cell set. In some cases, the indicator of the cells 1804 may be for multi-cell PUSCH/PDSCH transmission.

FIG. 19 is a diagram illustrating an example mapping 1900, according to various arrangements. The mapping 1900 may outline a mapping in one example embodiment for SRS DCI indication related to bandwidth aggregation. In some cases, the mapping 1900 may relate to intra-band contiguous carriers.

For example, bandwidth aggregation for positioning measurements may include aggregation across up to three intra-band contiguous carriers. A DCI may schedule SRS resources from multiple aggregated CCs. The DCI con-scheduled cells for positioning bandwidth aggregation may be based on a higher layer configuration of a network (e.g., gNB may configure at most three cells via RRC signaling). In some cases, the cells configured for positioning bandwidth aggregation via the RRC signaling may be RRC configured cell set2 for positioning CA 1912.

In some examples, the cell set2 1912 is associated with the cell set1 1902. For example, the cell set1 1902 may be a parent set of cells to the cell set2 1912 or the selection of cells in cell set2 1912 is based on the cell set1 1902. For instance, with reference to FIG. 19, the cell set1 1902 may include cell1 1904, cell2 1906, cell3 1908, and cell4 1910. The cell set2 may select two or three cells (e.g., cell1 1904 and cell3 1908) from the cell set1 1902. Cell set2 1912 may not select a cell that is not included in the cell set1 1902. By configuring the cell set2 1912, a network may inform the UE that the SRS resources of the cell set2 1912 are expected to be aggregated, transmitted from the same panel, the same antenna panel, and/or the same port.

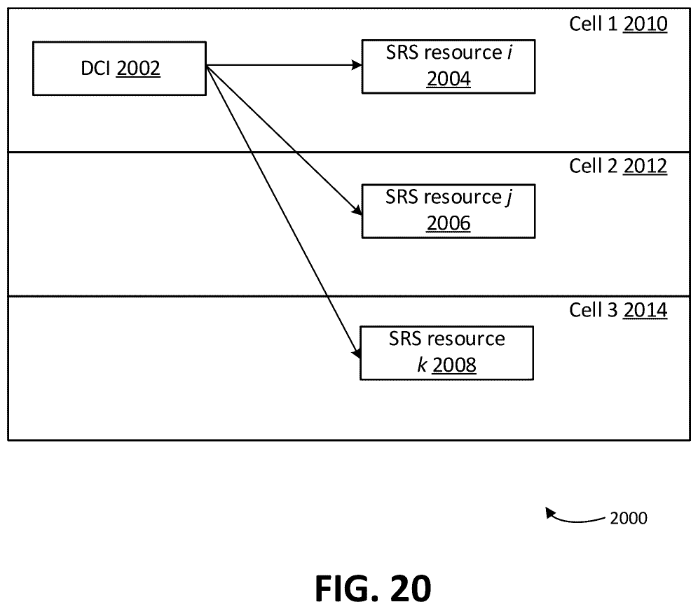

FIG. 20 is a diagram illustrating an example mapping 2000, according to various arrangements. The mapping 2000 may outline a mapping in one example embodiment for SRS DCI indication related to bandwidth aggregation. In some cases, the mapping 2000 may relate to DCI scheduling.

For instance, DCI scheduling may include a DCI 2002 for cell set1 1902 and cell set2 1912, as described herein with reference to FIG. 19. Cell set1 1902 may include cell1 1904, cell2 1906, cell3 1908, and cell4 1910. In some cases, the cell set2 1912 may select cell1 1904 and cell3 1908. The DCI 2002 may include an SRS request field and SRS offset indicator field for the cell1 1904, the cell2 1906, and the cell3 1908 (e.g., SRS resource i 2004, SRS resource j 2006, and SRS resource k 2008, respectively). The SRS request field and SRS offset indicator fields may indicate the cells for SRS transmission. In such a case, the cell1 1904 and the cell3 1908 are used for bandwidth aggregation SRS transmission (e.g., due to the cell set2 1912 selecting the cell1 1904 and the cell3 1908) and may meet a requirement (e.g., transmitted from a same antenna), but the SRS resource in cell2 1906 may not be transmitted from the same antenna as cell1 1904 or cell3 1908.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a wireless communication device, the method comprising:
receiving configuration for a downlink reference signal for bandwidth aggregation from a first node of a network;
receiving the downlink reference signal according to the configuration from a second node of the network; and
determining positioning measurement result for the downlink reference signal for the bandwidth aggregation.

2. The method of claim 1, wherein the configuration comprises higher layer signaling indicating that a plurality of Positioning Frequency Layers (PFLs) are linked, wherein each of the plurality of PFLs comprises at least one set of resource for the downlink reference signal.

3. The method of claim 1, wherein the configuration comprises an indication that a plurality of Positioning Frequency Layers (PFLs) are associated for the bandwidth aggregation, wherein each of the plurality of PFLs comprises at least set of one resource for the downlink reference signal.

4. The method of claim 1, wherein the configuration comprises an indicator indicating a resource set for a Transmission-Reception Point (TRP) for the downlink reference signal is used for bandwidth aggregation.

5. The method of claim 1, wherein
the network comprises Location Management Function (LMF) and a base station; and
the LMF sends a request the configuration to the base station, the request comprises a bandwidth aggregation indicator, the indicator comprises one bit indicating whether bandwidth aggregation for the downlink reference signal is needed.

6. The method of claim 1, comprising:
receiving a measurement request indicating that the wireless communication device is requested to report the positioning measurement result for the bandwidth aggregation from the first node of the network; and
reporting the positioning measurement result to the first node of the network, the positioning measurement result comprises at least one of:
a measurement indicator indicating that the positioning measurement result is determined by aggregating resources of a same Transmission-Reception Point (TRP) for the downlink reference signal; or
a list of resource set identifiers for measuring the downlink reference signal for each TRP for a measurement element.

7. The method of claim 1, comprising sending a request for assistance data to the first node of the network, wherein the request comprises at least one of:
a requested PRS configuration for transmission by the wireless communication device;
an indicator for a requested Positioning Frequency Layer (PFL) indicating whether the requested PFL is used for bandwidth aggregation; or
an indicator requesting a PFL group of a plurality of PFLs.

8. An apparatus for wireless communication comprising one or more processors, configured to cause the one or more processors to:
receive configuration for a downlink reference signal for bandwidth aggregation from a first node of a network;
receive the downlink reference signal according to the configuration from a second node of the network; and
determine positioning measurement result for the downlink reference signal for the bandwidth aggregation.

9. A wireless communication method performed by a first node and a second node of a network, comprising:
sending configuration for a downlink reference signal for bandwidth aggregation to a wireless communication device;
sending the downlink reference signal according to the configuration to the wireless communication device; and
receive positioning measurement result for the downlink reference signal for the bandwidth aggregation from the wireless communication device.

10. The method of claim 9, comprising receiving a response comprising a configuration of a Transmission-Reception Point (TRP) from the second node of the network, wherein the response comprises the configuration of the TRP, the configuration comprises a parameter corresponding to a list of resource sets for the TRP used for bandwidth aggregation.

11. A wireless communication apparatus of a network comprising the first network node and the second node of claim 9, wherein each of the first network node and the second node comprises at least one processor, wherein the at least one processor causes the apparatus to perform the method of claim 9.

12. A method, comprising:
receiving, by a wireless communication device from a network, Sounding Reference Signal (SRS) configuration for bandwidth aggregation, wherein the SRS configuration comprises a list of additional serving cells other than an initial component Carrier (CC) for the bandwidth aggregation, each of the additional serving cell is associated with a Bandwidth Part (BWP) configuration and positioning SRS configuration; and
sending, by the wireless communication device to the network according to the SRS configuration, an SRS.

13. An apparatus for wireless communication comprising one or more processors, wherein the one or more processors cause the apparatus to perform the method of claim 12.
